(19) United States
(12) Patent Application Publication
(10) Pub. No.: US 2006/0266696 A1
(43) Pub. Date: Nov. 30, 2006

(54) Inorganic separation membrane and method for manufacturing the same

(75) Inventors: Takao Masuda, Sapporo-shi (JP); Teruoki Tago, Sapporo-shi (JP); Shuichi Yoshida, Handa-shi (JP); Toshihiro Tomita, Nagoya-shi (JP); Kenji Suzuki, Nagoya-shi (JP)

Correspondence Address: BURR & BROWN, PO BOX 7068, SYRACUSE, NY, 13261-7068, US

(73) Assignees: NGK Insulators, Ltd., Nagoya-Shi (JP); National University Corporation Hokkaido University, Sapporo-Shi (JP)

(21) Appl. No.: 11/289,763

(22) Filed: Nov. 29, 2005

(30) Foreign Application Priority Data
May 26, 2005 (JP) 2005-153451

(51) Int. Cl. B01D 71/04

(52) U.S. Cl. 210/490; 210/500.26; 210/510.1

(57) ABSTRACT

The present invention provides an inorganic separation membrane including a silicalite nanocrystalline layer formed on a porous ceramic substrate, and a porous inorganic protective layer is formed on the nanocrystalline layer. The crystal grain diameter of the silicalite nanocrystal is preferably 150 nm or less, and the thickness of the silicalite nanocrystalline layer is preferably 1.0 to 4.0 μm. The separation membrane may be manufactured by: immersing a porous ceramic substrate in a dispersion solution of silicalite nanocrystals; laminating the silicalite nanocrystals on the surface of the porous ceramic substrate by evacuating the insider of the porous ceramic substrate; forming a porous inorganic protective layer on the silicalite nanocrystalline layer by a hydrothermal synthesis by heating after immersing the porous substrate in a zeolite synthesis solution containing a silica source; and removing organic components in the silicalite nanocrystal by liquid phase oxidation.

### BACKGROUND OF THE INVENTION

1. Field of the Invention

The present invention relates to an inorganic separation membrane suitable for separation and purification of a liquid phase mixture.

2. Description of the Related Art

While most of liquid phase mixtures in a chemical plant is separated and purified using distillation columns today, the number of plates and reflux ratios are rapidly increased for high degree of purification, causing energy burden to be enhanced. Accordingly, a membrane separation method is expected to be a promissing substitute of the distillation column method.

While separation membranes are classified into organic membranes and inorganic membranes, the organic membrane is defective in that it is usually poor in acid resistance, is soluble in organic solvents, and is likely to be deteriorated in selectivity due to swelling of the membrane. Since synthesis of the inorganic membrane is usually difficult, on the other hand, only a zeolite NaA membrane is practically used as a liquid separation membrane today.

Zeolite NaA exhibits strong hydrophilicity since cationic sites adjacent to Al components in the zeolite frame serve as hydrophilic groups. Accordingly, the zeolite may be utilized as a dehydration membrane, or a selective water-permeable membrane, for separating water from organic solvents and the like by forming the zeolite into a membrane. However, an Al eliminating reaction proceeds under an acidic condition in the zeolite containing a large amount of the Al component in the frame to readily cause collapse of a crystal structure. Consequently, it is impossible to use the zeolite membrane in separation of acidic liquids.

While acid resistance and hydrophilicity are tradeoff to one another in the zeolite, the inventors of the present invention have succeeded in developing a zeolite membrane having acid resistance and hydrophilicity together. The membrane comprises silicalite that is one kind of zeolite called zeolite MFI that contains no alumina components. It has been confirmed that highly selective water-permeability is attained by this membrane (T. Masuda et al., Separation and Purification Technology, 32, 181 (2003)). However, while the silicalite membrane had a high separation performance, its permeation rate was low and the membrane did not reach practical use.

### SUMMARY OF THE INVENTION

Accordingly, it is an object of the present invention to provide an inorganic separation membrane having acid resistance and hydrophilicity together while water permeation rate have been largely improved as compared with conventional separation membranes, and to provide a method for manufacturing the same.

The inorganic separation membrane of the present invention developed for solving the above-mentioned problems comprises a silicalite nanocrystalline layer formed on a porous ceramic substrate, and a porous inorganic protective layer is formed thereon. The inorganic separation membrane has a crystal grain diameter of silicalite nanocrystals, which constitutes the silicalite nanocrystalline layer, of preferably 100 nm or less, more preferably 60 nm or less. The inorganic separation membrane preferably has a thickness of the silicalite nanocrystalline layer of 1.3 μm to 4.0 μm. The porous inorganic protective layer preferably comprises silicalite or amorphous silica.

The present invention also provides a method for manufacturing an inorganic separation membrane comprising the steps of: immersing a porous ceramic substrate in a dispersion solution of silicalite nanocrystals; laminating the silicalite nanocrystals on the surface of the porous ceramic substrate by evacuating the permeate side of the porous ceramic substrate; forming a porous inorganic protective layer on the silicalite nanocrystalline layer by a hydrothermal synthesis by heating after immersing the porous substrate in a solution containing a silica source; and removing organic components in the silicalite nanocrystal by liquid phase oxidation with hydrogen peroxide. This liquid phase oxidation generates silanol groups on the outer surface and inside the crystal.

The inorganic separation membrane of the present invention comprises, different from conventional silicalite membranes for allowing water molecules to permeate by taking advantage of fine pores in the crystal, nanocrystalline crystals in which the size of the silicalite crystal is reduced to a nanometer order, and water is allowed to permeate by taking advantage of intercrystalline spaces of the crystal. The space between crystal grains of silicalite is filled with a network of water molecules formed on silanol groups on the surface of the crystal grains by hydrogen bonds in the separation membrane of the present invention, and water is selectively moved through the network. As a result, it has been made possible to increase the water permeation rate several tens times higher than the water permeation rate of conventional dense silicalite membranes while highly selective water-permeability is maintained. Although the silicalite nanocrystalline layer's own strength is poor, a practically available mechanical strength may be obtained by forming a porous inorganic protective layer on the surface of the monolayer.

According to the method for manufacturing the inorganic separation membrane of the present invention, it is possible to industrially manufacture the inorganic separation membrane having three layers of a ceramic porous substrate, a silicalite nanocrystalline layer and a porous inorganic protective layer.

### BRIEF DESCRIPTION OF THE DRAWINGS

FIG. 1 is a schematically illustrated cross sectional view of the membrane structure of the inorganic separation membrane of the present invention;

FIG. 2 describes a permeation mechanism of water molecules;

FIG. 3 is a graph showing the relation between the size of the silicalite nanocrystal crystal and water permeation rate; and

FIG. 4 is a graph showing the relation between the thickness of the silicalite nanocrystalline layer and water permeation rate.

### DESCRIPTION OF THE PREFERRED EMBODIMENTS

Preferred embodiments of the present invention will be described below.

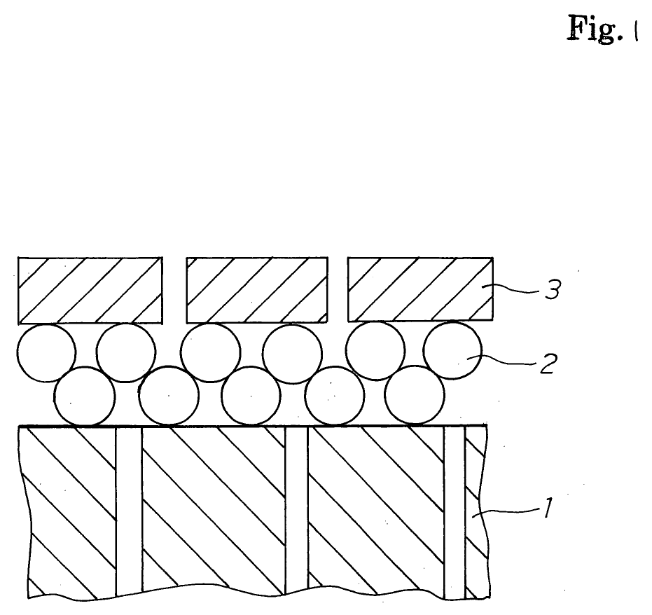

FIG. 1 is a schematically illustrated cross sectional view of the membrane structure of the inorganic separation membrane of the present invention. The reference numeral 1 denotes a porous ceramic substrate, the reference numeral 2 denotes a silicalite nanocrystalline layer laminated on the substrate, this silicalite has silanol groups on the outer surface and inside the crystals due to the treatment of the liquid phase oxidation with hydrogen peroxide, and the reference numeral 3 denotes a porous inorganic layer formed on the nanocrystalline layer. While the material of the porous ceramic substrate 1 is not particularly restricted, an alumina filter (cylindrical alumina filter) excellent in acid resistance was used in this embodiment.

The silicalite nanocrystalline layer 2 comprises an assembly of silicalite crystals having a nanometer order of crystal size, and exhibits selective water permeability. Silicalite is a crystal containing no alumina components of zeolite MFI, has excellent acid resistance and hydrophilicity and is able to permit water molecules to selectively move both in the crystal and in the aperture among the crystals.

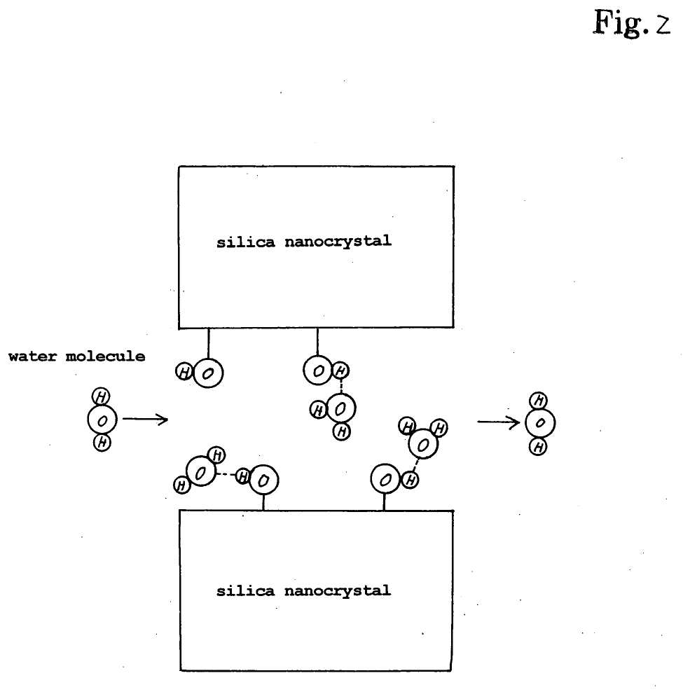

While a conventional silicalite membrane comprises dense silicalite crystals with a crystal size of several micrometers that permits water molecules to selectively permeate by taking advantage of fine pores in the crystal, the crystal diameter of the silicalite nanocrystals constructing the silicalite nanocrystalline layer 2 is reduced to a nanometer order in the present invention, and the water molecules are allowed to permeate by taking advantage of a network of the silanol group-water molecule formed in the space between the crystals as shown in FIG. 2. Specifically, the crystal diameter of the silicalite crystals is preferably 100 nm or less, more preferably 60 nm or less. Since reducing the crystal size as described above permits the number of spaces between the crystal grains to be increased, it was confirmed that water permeation rate may be largely increased as compared with conventional dense silicalite membrane. According to the data in examples hereinafter, the water permeation rate reaches about 100 times of that of the conventional silicalite membrane when the crystal diameter is reduced to 60 nm.

The thickness of the silicalite nanocrystalline layer 2 is preferably 1.3 to 4.0 nm. When the thickness of the silicalite nanocrystalline layer 2 is smaller than the range described above, a dense protective layer 3 is formed on the nanocrystalline layer utilizing the nanocrystals as crystallization nuclei, which may block water from permeating the layer. On the contrary, permeation of water may be also blocked when the thickness is larger than the range described above.

The porous inorganic protective layer 3 prevents the silica nanocrystalline layer 2 from peeling and ensures mechanical strength as a film. A silicalite layer with a crystal size of several micrometers was formed on the nanocrystalline layer 2 by hydrothermal synthesis in this embodiment. However, the protective layer 3 is not restricted to the silicalite layer, instead an amorphous silica layer may be formed. The protective layer 3 should comprise a porous material that does not block water from permeating.

The inorganic separation membrane of the present invention may be manufactured by a method comprising the steps of: immersing a porous ceramic substrate 1 in a dispersion solution of silicalite nanocrystals; laminating the silicalite nanocrystals on the surface of the porous ceramic substrate 1 by evacuating the permeate side of the porous ceramic substrate; forming a porous inorganic protective layer 3 on the silicalite nanocrystalline layer 2 by a hydrothermal synthesis by heating after immersing the porous substrate in a zeolite synthesis solution; and removing organic components in the silicalite nanocrystals by liquid phase oxidation with hydrogen peroxide. The method is described in detail in the example below.

### EXAMPLE

The inorganic separation membrane was manufactured by the following method using three kinds of the silicalite nanocrystals with crystal sizes of 60 nm, 100 nm and 150 nm, respectively.

Silicalite nanocrystals were added in distilled water whose pH was adjusted to 10 using sodium hydroxide, and the crystals were allowed to disperse for 15 minutes with ultrasonic wave. A cylindrical alumina filter with an outer diameter of 11 mm and a length of 55 mm was immersed in this solution, and a silicalite nanocrystalline layer with a thickness of 1.3 to 4.0 μm was formed on the outer circumference face of the cylindrical alumina filter by evacuating the inside of the filter.

Then, 5.4 g of sodium silicate as a silica source, 3.5 g of sodium chloride as a stabilizer, and 1.18 g of tetrapropylammonium bromide as a template (a structure determining agent) were mixed with 280 g of distilled water to prepare a solution for synthesizing zeolite by adjusting the pH of the solution to 9.5. The alumina filter having a silica nanocrystalline layer formed on the outer circumference face of the cylindrical filter was immersed in the solution, and a protective layer comprising silicalite with a thickness of about 1.0 μm was formed by hydrothermal synthesis by heating at 140° C. for 24 hours. After the synthesis, the inorganic separation membrane obtained was washed with distilled water. After spontaneous drying, the filter was treated by the liquid phase oxidation with an aqueous nitric acid solution containing an aqueous hydrogen peroxide solution at 90° C. for 24 hours. This treatment was repeated three times. After completing the treatment, the filter was washed with ion-exchange water.

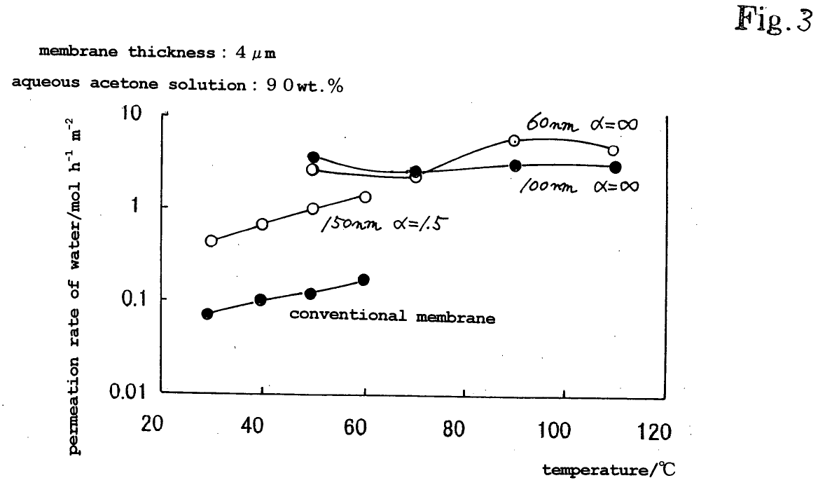

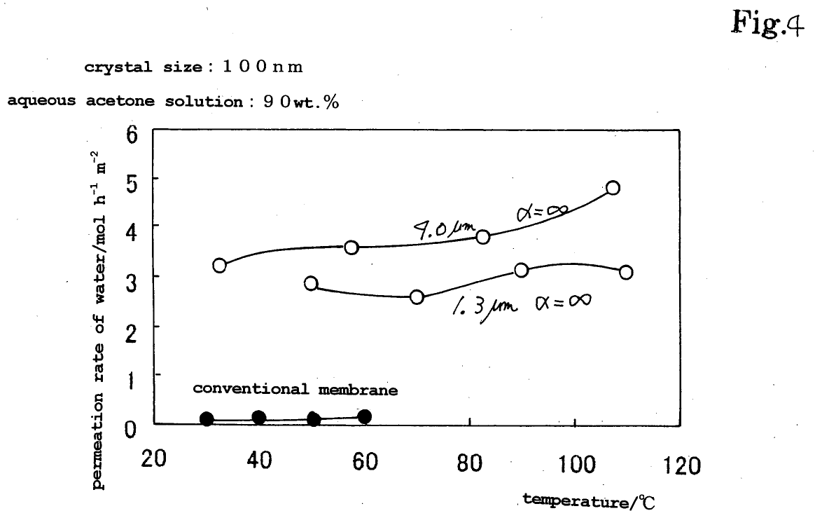

The performance of the inorganic separation membrane as a selective water-permeable membrane was assessed by a pervaporation method using an aqueous acetone solution containing 10% by volume of water. In the experiment, the inorganic separation membrane was placed in an autoclave vessel filled with a aqueous acetone solution, nitrogen gas as a carrier gas was allowed to flow within the inorganic separation membrane, and the amount of water transferred to the carrier gas side was assayed by gas chromatography. The temperature within the autoclave vessel was changed in order to confirm the effect of the temperature. The results are shown in FIGS. 3 and 4.

FIG. 3 is a graph showing the relation between the crystal size of the silicalite nanocrystals and water permeation rate. While the water permeation rate of the conventional dense silicalite membrane was 0.1 (unit: mole·h⁻¹·m⁻²), the water permeation rate was increased to 5 to 10 that is about 100 times of the rate of the conventional membrane, when the crystal size was 60 nm and 100 nm. The water permeation rate was around 1 that is about 10 times or more of the rate of the conventional membrane, when the crystal size was 150 nm. The separation factor of water was infinite when the crystal size was 60 nm and 100 nm, and only water permeated through the membrane without permitting acetone to permeate at all. The separation factor was 1.5 when the crystal size was 150 nm. The separation factor here is defined as (molar concentration of water at the permeation side/molar concentration of aceton at the permeation side)÷(molar concentration of water at the feed side/molar concentration of acetone at the feed side).

FIG. 4 is a graph showing the relation between the thickness of the silicalite nanocrystalline layer and water permeation rate. The crystal size of the silicalite nanocrystals was 100 nm. The water permeation rate of the conventional dense silicalite membrane is 0.1. On the contrary, the water permeation rate of the membrane of the present invention was 3 to 5, which is 30 to 50 times higher than the permeation rate of the conventional membrane, even when the thickness of the silicalite nanocrystalline layer is either 1.3 μm or 4.0 μm. The separation factor of water was infinite in both cases, and water could be selectively permeated without permitting acetone to be permeated at all.

As shown by the experimental results in the examples above, the inorganic separation membrane of the present invention enabled the permeation rate to be increased several tens times higher than the permeation rate of the conventional dense silicalite membrane while maintaining high selective permeability of water. The membrane of the present invention is practically valuable as a substitute technology for separation and purification of liquid phase mixtures by a distillation column that requires high energy burden.

Accordingly, the separation membrane of the present invention can be used for high degree of purification by selectively separating water from a liquid phase mixture in a chemical plant.

1. An inorganic separation membrane comprising a silicalite nanocrystalline layer formed on a porous ceramic substrate, a porous inorganic protective layer being formed thereon.

2. The inorganic separation membrane according to claim 1 having a crystal grain diameter of silicalite nanocrystals constituting the silicalite nanocrystalline layer of 100 nm or less.

3. The inorganic separation membrane according to claim 1 having a thickness of the silicalite nanocrystalline layer of 1.3 μm to 4.0 μm.

4. The inorganic separation membrane according to claim 1 having the porous inorganic protective layer comprising silicalite or amorphous silica.

5. A method for manufacturing an inorganic separation membrane comprising the steps of: immersing a porous ceramic substrate in a dispersion solution of silicalite nanocrystals; laminating the silicalite nanocrystals on the surface of the porous ceramic substrate by evacuating the inside of the porous ceramic substrate; forming a porous inorganic protective layer on the silicalite nanocrystalline layer by a hydrothermal synthesis by heating after immersing the porous substrate in a solution; and removing organic components in the silicalite nanocrystal by liquid phase oxidation.
